(19) United States
(12) Patent Application Publication
(10) Pub. No.: US 2024/0070987 A1
(43) Pub. Date: Feb. 29, 2024

(54) POSE TRANSFER FOR THREE-DIMENSIONAL CHARACTERS USING A LEARNED SHAPE CODE

(71) Applicant: NVIDIA Corporation, Santa Clara, CA (US)

(72) Inventors: Xueting Li, San Jose, CA (US); Sifei Liu, Santa Clara, CA (US); Shalini De Mello, San Francisco, CA (US); Orazio Gallo, Santa Cruz, CA (US); Jiashun Wang, La Jolla, CA (US); Jan Kautz, Lexington, MA (US)

(21) Appl. No.: 18/110,287

(22) Filed: Feb. 15, 2023

Related U.S. Application Data
(60) Provisional application No. 63/402,815, filed on Aug. 31, 2022.

(51) Int. Cl. G06T 19/00; G06T 7/10; G06T 17/20

(52) U.S. Cl. CPC G06T 19/00; G06T 7/10; G06T 17/20

(57) ABSTRACT

Transferring pose to three-dimensional characters is a common computer graphics task that typically involves transferring the pose of a reference avatar to a (stylized) three-dimensional character. Since three-dimensional characters are created by professional artists through imagination and exaggeration, and therefore, unlike human or animal avatars, have distinct shape and features, matching the pose of a three-dimensional character to that of a reference avatar generally requires manually creating shape information for the three-dimensional character that is required for pose transfer. The present disclosure provides for the automated transfer of a reference pose to a three-dimensional character, based specifically on a learned shape code for the three-dimensional character.

### RELATED APPLICATION(S)

This application claims the benefit of U.S. Provisional Application No. 63/402,815 (Attorney Docket No. NVIDP1358+/22-SC-1164US01), titled “SKELETON AND SKINNING-WEIGHT FREE POSE TRANSFER” and filed Aug. 31, 2022, the entire contents of which is incorporated herein by reference.

### TECHNICAL FIELD

The present disclosure relates to transferring pose to three-dimensional characters.

### BACKGROUND

Transferring pose to three-dimensional characters is a common computer graphics task that typically involves transferring the pose of a reference avatar to a (stylized) three-dimensional character. Because three-dimensional characters are commonly used in animation, movies, and video games, deforming these characters to mimic natural human or animal poses has been a long-standing computer graphics task.

Different from the three-dimensional models of natural humans and animals, three-dimensional characters are usually created (e.g. by professional artists) through imagination and exaggeration. As a result, each character has a distinct skeleton, shape, mesh topology, and may include various accessories, such as a cloak or wings. These variations from natural humans and animals hinder the process of matching the pose of a three-dimensional character to that of a reference human/animal avatar, generally making manual rigging a requirement. However, rigging is a tedious process that, to date, has required manually creating the skeleton and skinning weights for each character. Even when provided with manually annotated rigs, transferring poses from a driving avatar onto three-dimensional characters is not trivial when the source (avatar) and target (character) skeletons differ.

There is a need for addressing these issues and/or other issues associated with the prior art. For example, there is a need to automate the transfer of a reference pose to a three-dimensional character.

### SUMMARY

A method, computer readable medium, and system are disclosed for learning a shape code for a three-dimensional character, which may be used for a pose transfer to the three-dimensional character. A three-dimensional character, in a source pose, is processed using a machine learning model, to learn a latent shape code for the three-dimensional character. The latent shape code includes shape information for the three-dimensional character, and a plurality of body part segmentation labels for the three-dimensional character, each body part segmentation label of the plurality of body part segmentation labels being for a corresponding surface point in a set of surface points on the three-dimensional character. The latent shape code is then output.

In an embodiment, the latent shape code is output to a second machine learning model configured to deform the three-dimensional character into a target pose. In an embodiment, the latent shape code and a target pose code corresponding to the target pose are processed, using the second machine learning model, to deform the three-dimensional character into the target pose.

In an embodiment, the three-dimensional character in the target pose is output for applying a volume-preserving constraint to the deformed three-dimensional character. In an embodiment, the volume-preserving constraint preserves, in the three-dimensional character in the target pose, a volume of each body part of the three-dimensional character in the source pose. In an embodiment, test-time training of the second machine learning model is performed to optimize the weights of the second machine learning model by fine-tuning on the given pose and stylized character with the volume-preserving objective, such that it can deform the character to the target pose more naturally and smoothly.

### BRIEF DESCRIPTION OF THE DRAWINGS

FIG. 1 illustrates a flowchart of a method for learning a shape code for a three-dimensional character, in accordance with an embodiment.

FIG. 2 illustrates a flowchart of a method for transferring a pose from a source avatar to a three-dimensional character using a learned shape code, in accordance with an embodiment.

FIG. 3 illustrates a system for transferring a pose from a source avatar to a three-dimensional character using a learned shape code, in accordance with an embodiment.

FIG. 4 illustrates a flow diagram of a shape understanding module of a system, in accordance with an embodiment.

FIG. 5 illustrates a flow diagram of a pose deformation module of a system, in accordance with an embodiment.

FIG. 6 illustrates exemplary pose transfer from a source avatar to a three-dimensional character, in accordance with an embodiment.

FIG. 7A illustrates inference and/or training logic, according to at least one

embodiment.

FIG. 7B illustrates inference and/or training logic, according to at least one embodiment.

FIG. 8 illustrates training and deployment of a neural network, according to at least

one embodiment.

FIG. 9 illustrates an example data center system, according to at least one embodiment.

### DETAILED DESCRIPTION

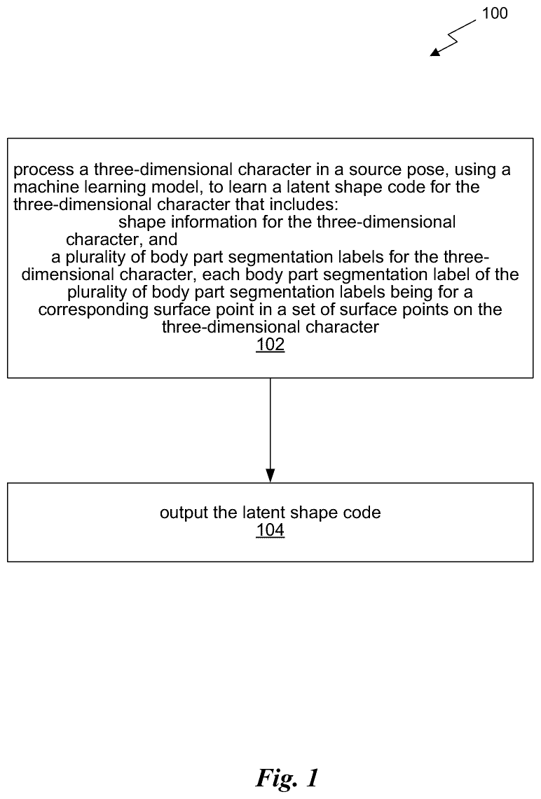

FIG. 1 illustrates a flowchart of a method 100 for learning a shape code for a three-dimensional character, in accordance with an embodiment. The method 100 may be performed by a device, which may be comprised of a processing unit, a program, custom circuitry, or a combination thereof, in an embodiment. In another embodiment a system comprised of a non-transitory memory storage comprising instructions, and one or more processors in communication with the memory, may execute the instructions to perform the method 100. In another embodiment, a non-transitory computer-readable media may store computer instructions which when executed by one or more processors of a device cause the device to perform the method 100.

In operation 102, a three-dimensional character, in a source pose, is processed using a machine learning model, to learn a latent shape code for the three-dimensional character. With respect to the present description, the three-dimensional character refers to any stylized character created in three-dimensions, such as a stylized quadruped or a stylized biped. The term “stylized” refers to having features that would not usually be present in the real world, such as exaggerated physical proportions (e.g. skeleton, shape, etc.), uncommon accessories (e.g. cloak, wings, etc.), etc. In an embodiment, the three-dimensional character may be created by a human (e.g. artist or animator).

The source pose of the three-dimensional character refers to the given pose of the three-dimensional character. The given pose may be the pose in which the three-dimensional character was created. In general, a pose may be represented by a certain posture of the three-dimensional character, limb placement of the three-dimensional character, rotation of the three-dimensional character with respect to a camera view, etc. In one embodiment, the source pose may be a rest pose (i.e. a pose of the three-dimensional character when at rest).

As mentioned above, the three-dimensional character is processed using a machine learning model to learn a latent shape code for the three-dimensional character. With respect to the present description, the latent shape code includes shape information for the three-dimensional character. The shape information may be any information that defines a shape of the three-dimensional character. In an embodiment, the shape information may include a shape of each body part of the three-dimensional character (e.g. head, torso, limbs, etc.). In an embodiment, the shape information may further include a physical height of the three-dimensional character and/or its body parts and/or a physical weight of the three-dimensional character and/or its body parts.

Also with respect to the present description, the latent shape code includes a plurality of body part segmentation labels for the three-dimensional character, where each of the body part segmentation labels is for a corresponding surface point in a set of surface points on the three-dimensional character. In other words, for a defined set of points on a surface of the three-dimensional character (i.e. the set of surface points), the latent shape code may include a label for each point that indicates a body part of the three-dimensional character on which the point is located.

The machine learning model that is used to learn the latent shape code for the three-dimensional character refers to any model trained using machine learning to infer a latent shape code (as defined above) for a given three-dimensional character in a given (source) pose. In an embodiment, the machine learning model may be trained for a type of the three-dimensional character (i.e. quadruped or biped). In an embodiment, however, the given three-dimensional character may be unseen during training of the machine learning model (i.e. the machine learning model may not be specifically trained on the given three-dimensional character).

In an embodiment, the machine learning model (e.g. for bipeds) may be trained using supervised learning on a training data set that includes naked human meshes having occupancy labels and part segmentation labels, and a plurality of other three-dimensional (biped) character rest pose meshes having occupancy labels, wherein an occupancy label indicates whether a corresponding query point is inside or outside a body surface. Likewise, in another embodiment, the machine learning model (e.g. for quadrupeds) may be trained using supervised learning on a training data set that includes animal meshes having occupancy labels and part segmentation labels, and a plurality of other three-dimensional (quadruped) character rest pose meshes having occupancy labels, wherein an occupancy label indicates whether a corresponding query point is inside or outside a body surface.

In an embodiment, the latent shape code may be learned using an implicit auto-decoder that takes a learnable shape code as input and that reconstructs the three-dimensional character. In an embodiment, the machine learning model may include a first multilayer perceptron (MLP) that, given a query point on the three-dimensional character and a learnable shape code, obtains an embedding. In an embodiment, the machine learning model may include a second MLP that, given the embedding, predicts an occupancy that indicates whether the query point is inside or outside a body surface of the three-dimensional character. In an embodiment, the machine learning model may include a third MLP that, given the embedding, predicts the part segmentation label for the query point. In an embodiment, the machine learning model may further include an inverse MLP that, given the learnable shape code and the embedding, reconstructs coordinates of the query point.

In operation 104, the latent shape code is output. In an embodiment, the latent shape code may be output by the machine learning model. In an embodiment, the latent shape code may be output to a post-processor which performs some post-processing on the latent shape code learned and output by the machine learning model.

In an embodiment, as described in more detail with reference to one or more of the subsequent figures below, the latent shape code may be used for a pose transfer to the three-dimensional character. Accordingly, in an embodiment, the latent shape code may be output for use in deforming the three-dimensional character into a target pose. It should be noted, however, that the latent shape code may be used for any other computer graphics tasks associated with the three-dimensional character and is not necessarily limited to use for a pose transfer to the three-dimensional character. In an exemplary embodiment, the latent shape codes of different three-dimensional characters may be computed, and clustering on these codes, or comparing their similarity, may be performed. For example, in fine-grained animal mesh classification, the latent shape code may be used to determine if two meshes have similar shape, or belong to the same category.

The embodiments disclosed herein with reference to the method 100 of FIG. 1 may apply to and/or be used in combination with any of the embodiments of the remaining figures below.

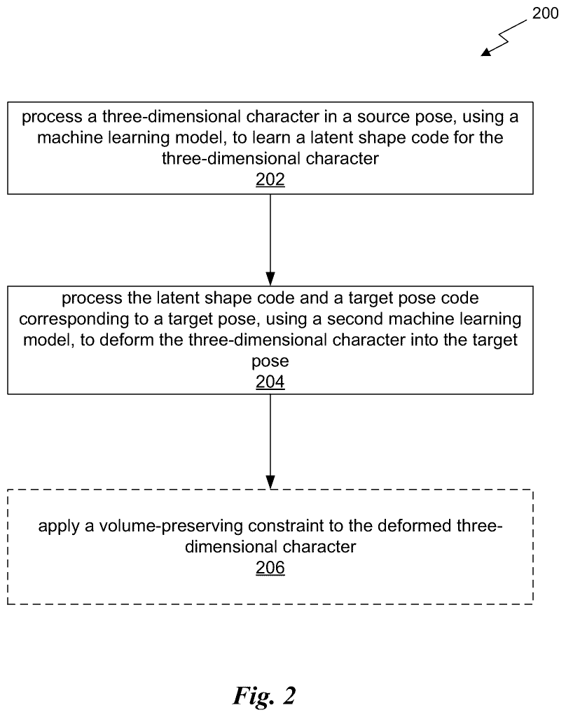

FIG. 2 illustrates a flowchart of a method 200 for transferring a pose from a source avatar to a three-dimensional character using a learned shape code, in accordance with an embodiment.

In operation 202, a three-dimensional character, in a source pose, is processed using a machine learning model, to learn a latent shape code for the three-dimensional character. Operation 202 may be performed as described above with reference to operation 102 of FIG. 1. In the present embodiment, the latent shape code learned by the machine learning model may be output to a second machine learning model configured to deform the three-dimensional character into a target pose.

In particular, in operation 204, the latent shape code and a target pose code corresponding to the target pose are processed, using the second machine learning model, to deform the three-dimensional character into the target pose. The target pose refers to a given pose into which the three-dimensional character is to be deformed. Thus, in the present embodiment, the target pose differs from the source pose of the three-dimensional character. In an embodiment, the target pose may be indicated by a non-stylized avatar (e.g. human or animal, per the type of three-dimensional character being deformed). The target pose code refers to any code that defines the target pose for the three-dimensional character. In an embodiment, the target pose code may be captured from an image, a video, or a three-dimensional human or animal.

With respect to the present embodiment, deforming the three-dimensional character into the target pose refers to creating an instance of the three-dimensional character in the target pose. In an embodiment, deforming the three-dimensional character into the target pose may include deforming each surface point in the set of surface points on the three-dimensional character to match the target pose.

In an embodiment, the second machine learning model may include a MLP that, given the latent shape code, the target pose code, and a query point, predicts an offset of the query point in three-dimensional space. In an embodiment, the second machine learning model configured for biped characters may be trained using supervised learning on a training data set that includes human meshes in rest pose, and deformations of the human meshes into a plurality of predefined target poses. Likewise, the second machine learning model configured for quadruped characters may be trained using supervised learning on a training data set that includes animal meshes in rest pose, and deformations of the animal meshes into a plurality of predefined target poses.

In the present embodiment, the deformed three-dimensional character may be output for applying a volume-preserving constraint to the deformed three-dimensional character. Specifically, in operation 206 (which may be selectively included in the method 200 per user design preference) a volume-preserving constraint is applied to the deformed three-dimensional character.

In an embodiment, the volume-preserving constraint may preserve, in the three-dimensional character in the target pose, a volume of each body part of the three-dimensional character in the source pose. In an embodiment, the volume of each body part of the three-dimensional character in the source pose may be represented by a Euclidean distance between a plurality of pairs of surface points. In an embodiment, the volume of each body part of the three-dimensional character in the source pose may be preserved by minimizing, for each pair of surface points, a change in a distance of the two surface points in the pair on the three-dimensional character in the target pose, wherein the change is minimized according to a predefined function. In an embodiment, test-time training of the second machine learning model may then be performed to optimize the weights of the second machine learning model by fine-tuning on the given pose and stylized character with the volume-preserving objective, such that it can deform the character to the target pose more naturally and smoothly.

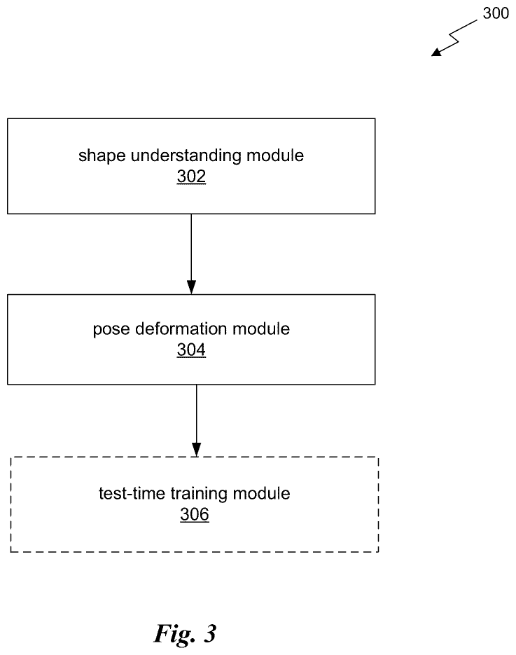

FIG. 3 illustrates a system 300 for transferring a pose from a source avatar to a three-dimensional character using a learned shape code, in accordance with an embodiment.

This may include specifically transferring the pose of a biped or quadruped avatar to an unrigged, stylized 3D character. The system 300 may be implemented to perform the method 200 of FIG. 2, in one embodiment. The system 300 includes modules 302-304, and selectively includes module 306 per user design preference, each of which may be hardware and/or software configured to perform functionality as described herein.

The system 300 accomplishes the pose transfer by modeling the shape and pose of a 3D character using a correspondence-aware shape understanding module 302 and an implicit pose deformation module 304. The shape understanding module 302 predicts a latent shape code, which includes shape information for the three-dimensional character as well as body part segmentation labels for select surface points on the three-dimensional character. The pose deformation module 304 deforms the three-dimensional character in the rest pose given the predicted shape code and a target pose code.

Moreover, to produce natural deformations and generalize to rare poses unseen at training, the system 300 may also include an efficient volume-based test-time training module 306 which includes a procedure configured for unseen stylized characters. All three modules 302-306, trained only with posed, unclothed human meshes, and unrigged, stylized characters in a rest pose, are directly applied to unseen stylized characters at inference.

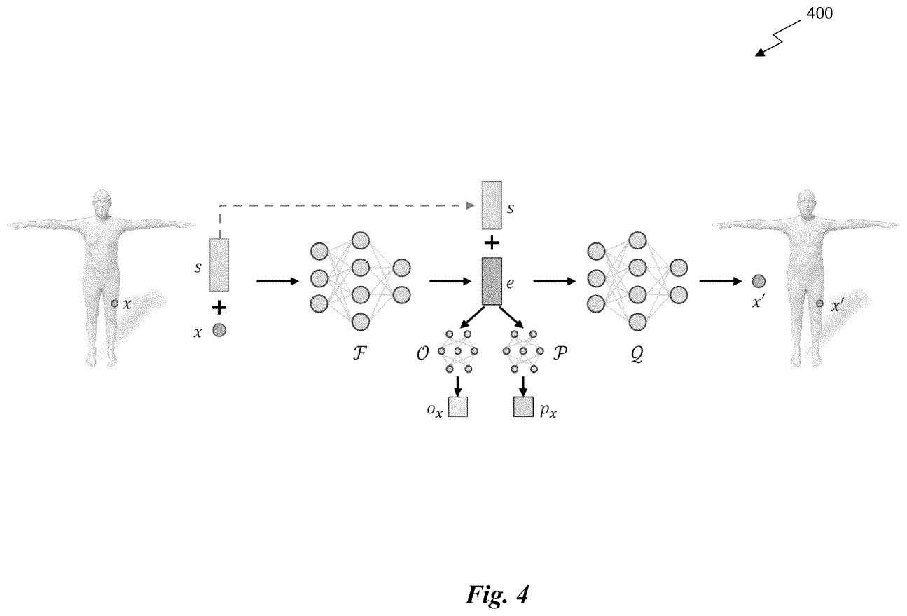

FIG. 4 illustrates a flow diagram of a shape understanding module 400 of a system, in accordance with an embodiment. The shape understanding module 400 may include the shape understanding module 302 of the system 300 of FIG. 3, in an embodiment.

Given a three-dimensional character in rest pose, the shape understanding module 400 is used to represent its shape information as a latent shape code having both shape information for the three-dimensional character as well as predicted body part segmentation labels for a set of surface points.

To learn a representative shape code, the shape understanding module 400 employs an implicit auto-decoder that reconstructs the three-dimensional character taking the shape code as input. During training, the shape understanding module 400 jointly optimizes the shape code of each training sample and the decoder. Given an unseen character (i.e. a stylized three-dimensional character) during inference, the shape understanding module 400 obtains its shape code by freezing the decoder and optimizing the shape code to reconstruct the given character.

Specifically, as shown, given the concatenation of a query point x∈ [symbol] ³ and the shape code s∈ [symbol] ^{d}, the shape understanding module 400 first obtains an embedding e∈ [symbol] ^{d} via an MLP denoted as F. Conditioned on the embedding e, the occupancy ôₓ∈ [symbol] of x is then predicted by another MLP denoted as O. The occupancy indicates if the query point x is inside or outside the body surface and can be supervised by the ground truth occupancy according to Equation 1:

[symbol]

ₒ=−Σₓ(oₓ·log(ôₓ)+(1−oₓ)·log (1−ôₓ)), Equation 1

where oₓ is the ground truth occupancy at point x.

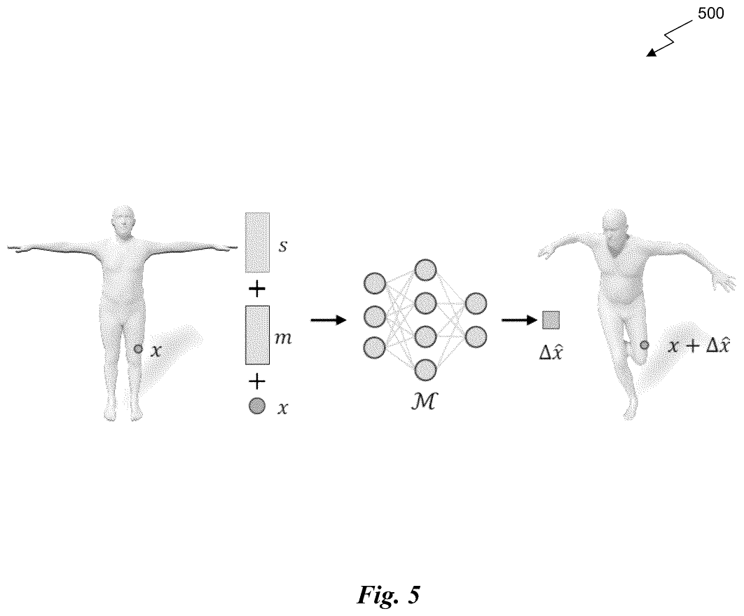

Since the latent shape code, in one embodiment, eventually serves as a condition for the pose deformation module (FIG. 5), the latent shape code may also capture the part correspondence knowledge across different instances, in addition to the shape information (e.g., height, weight, and shape of each body part). The pose deformation process could benefit from learning part correspondence. For example, some three-dimensional characters may have headgear, hats, and horns on their heads. If these components can be “understood” as extensions of the character's heads by their shape codes, they will move smoothly with the character's heads during pose deformation. Thus, besides mesh reconstruction for the three-dimensional character, the shape understanding module 400 is tasked with an additional objective: predicting part-level correspondence instantiated as the part segmentation label. Specifically, the shape understanding module 400 may utilize an MLP P to additionally predict a part label px=(pₓ¹, . . . , pₓ^{K})^{T}∈ [symbol] ^{K} for each surface point x. Using an existing densely annotated human mesh dataset, part segmentation learning can be supervised with ground truth labels via Equation 2:

[symbol]

_{P}=Σₓ(−Σₖ₌₁ [symbol] ₓ^{k} log (pₓ^{k})), Equation 2

where K is the total number of body parts, and [symbol] ₓ^{k}=1 if x belongs to the kth part and [symbol] ₓ^{k}=0 otherwise.

To prepare the shape understanding module 400 for stylized characters during inference, besides unclothed human meshes, unrigged three-dimensional stylized characters in rest pose may also be included during training. These characters in rest pose are easily accessible and do not require any annotation. For shape reconstruction, Equation 1 can be similarly applied to the stylized characters. However, as there is no part segmentation annotation for stylized characters, a self-supervised inverse constraint may be used to facilitate part segmentation prediction on these characters. Specifically, the query point's coordinates may be reconstructed from the concatenation of the shape code s and the embedding e through an MLP Q and an auxiliary objective may be added as in Equation 3:

[symbol]

_{Q}=∥Q(s,e)−x∥² Equation 3

Intuitively, for stylized characters without part annotation, the model learned without this objective may converge to a trivial solution where similar embeddings are predicted for points with the same occupancy value, even when they are far away from each other, and belong to different body parts. Beyond facilitating shape understanding, the predicted part segmentation label can be further utilized in the volume-based test-time training module (item 306 of FIG. 3) which will be described in more detail below.

FIG. 5 illustrates a flow diagram of a pose deformation module 500 of a system, in accordance with an embodiment. The pose deformation module 500 may include the pose deformation module 304 of the system 300 of FIG. 3, in an embodiment.

Given the learned shape code and a target pose, the pose deformation module 500 deforms each surface point of the character to match the target pose. Instead of learning a latent pose space from scratch, a human pose is represented by the corresponding pose code in a latent space (e.g. of VPoser, since VPoser is trained with an abundance of posed humans from the large-scale AMASS dataset). This facilitates faster training and provides robustness to overfitting. Furthermore, human poses can be successfully estimated from different modalities (e.g., videos or meshes), and mapped to the latent space. By taking advantage of these configurations, the model used by the pose deformation module 500 can be applied to transfer poses from various modalities to an unrigged stylized character without any additional effort.

To deform a character to match the given (target) pose, a neural implicit function M is learned that takes the sampled pose code m∈ [symbol] ³², the learned shape code, and a query point x around the character's surface as inputs and output the offset (denoted as Δ\hat{x}∈ [symbol] 32) of x in three-dimensional space. Given the densely annotated human mesh dataset, the ground truth offset Δx may be directly used as supervision. The training objective for the pose deformation module 500 is defined as in Equation 4:

[symbol]

_{D}=Σₓ∥Δ\hat{x}−Δx∥² Equation 4

The pose deformation module 500 is accordingly agnostic to mesh topology and resolution. Thus, the model can be directly applied to unseen three-dimensional stylized characters with significantly different resolutions and mesh topology compared to the training human meshes during inference. Second, while stylized characters often include distinct body part shapes compared to humans (e.g. bigger heads or various accessories), the pose deformation module 500 learns to deform individual surface points, such that the implicit functions are more agnostic to the overall shape of a body part and thus can generalize better to stylized characters with significantly different body part shapes.

Test-Time Training

The shape understanding and pose deformation modules 400, 500 discussed above are, in an embodiment, trained with only posed human meshes and unrigged 3D stylized characters in rest pose. When applied to unseen characters with significantly different shapes, surface distortion may be introduced by the pose deformation module 500. Moreover, it may be challenging for the module to fully capture the long tail of the pose distribution.

To resolve these issues, a test-time training may be applied, and the pose deformation module 500 may be fine-tuned on unseen stylized characters.

To encourage natural pose deformation, a volume-preserving constraint may be used during test-time training. Preserving the volume of each part in the rest pose mesh during pose deformation results in less distortion. However, it is non-trivial to compute the precise volume of each body part, which can have complex geometry. Instead, the Euclidean distance between pairs of vertices sampled from the surface of the mesh is preserved, as a proxy for constraining the volume. Specifically, given a mesh in rest pose, two points xᵢ^{c} and xⱼ^{c} are randomly sampled on the surface within the same part c using the part segmentation prediction from the shape understanding module 500. The offset of these two points Δ\hat{x}ᵢ^{c} and Δ\hat{x}ⱼ^{c} is calculated the pose deformation module 500 and the change in the distance between them is minimized by Equation 5:

$${{ℒ}_{v} = {\sum }_{c} {\sum }_{i} {\sum }_{j} ‖ {x}_{i}^{c} - {x}_{j}^{c} ‖ - ‖ ( {x}_{i}^{c} + Δ {\hat{x}}_{i}^{c} ) - {x}_{j}^{c} + Δ {\hat{x}}_{j}^{c} ) ‖}^{2} . \qquad Equation 5$$

By sampling a large number of point pairs within a part and minimizing Equation 5, the volume of each body part can be approximately maintained during pose deformation.

Furthermore, in order to generalize the pose deformation module 500 to long-tail poses that are rarely seen during training, the driving character in rest pose and its deformed shape may be used as paired training data during test-time training. Specifically, the driving character in rest pose, its target pose code, and its optimized shape code may be used as inputs and the movement Δ\hat{x}^{dr}, where x^{dr} is a query point from the driving character. The L2 distance between the predicted movement Δ\hat{x}^{dr} and the ground truth movement Δx^{dr} is minimized by Equation 6:

[symbol]

_{dr}=Σₓ_{^{dr}}∥Δ\hat{x}^{dr}−Δx^{dr}∥² Equation 6

Besides the volume-preserving constraint and the reconstruction of the driving character, an edge loss [symbol] ₑ may also be employed. Overall, the objectives for the test-time training procedure are [symbol] _{T}=λᵥ [symbol] ᵥ+λₑ [symbol] ₑ+λ_{dr} [symbol] _{dr}, where λᵥ, λₑ, and λ_{dr} are hyper-parameters balancing the loss weights.

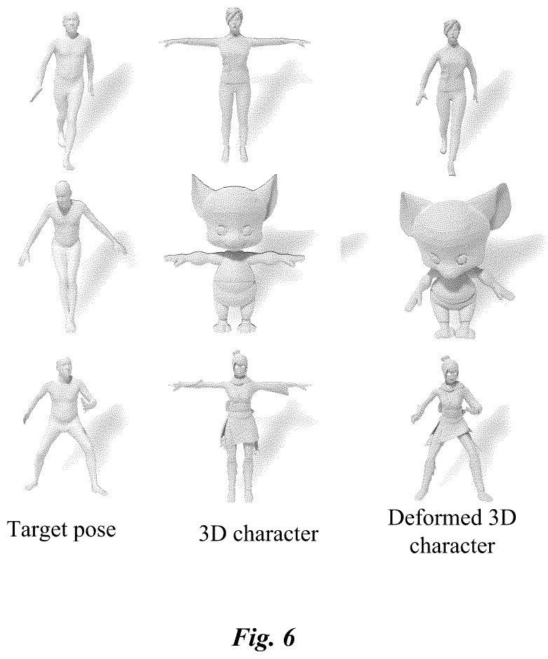

FIG. 6 illustrates exemplary pose transfer from a source avatar to a three-dimensional character, in accordance with an embodiment. The pose transfer may be performed in accordance with the method 200 of FIG. 2 and/or using the system 300 of FIG. 3. For a given target pose and a three-dimensional character in rest pose, the three-dimensional character is deformed into the target pose, as illustrated.

### Machine Learning

Deep neural networks (DNNs), including deep learning models, developed on processors have been used for diverse use cases, from self-driving cars to faster drug development, from automatic image captioning in online image databases to smart real-time language translation in video chat applications. Deep learning is a technique that models the neural learning process of the human brain, continually learning, continually getting smarter, and delivering more accurate results more quickly over time. A child is initially taught by an adult to correctly identify and classify various shapes, eventually being able to identify shapes without any coaching. Similarly, a deep learning or neural learning system needs to be trained in object recognition and classification for it get smarter and more efficient at identifying basic objects, occluded objects, etc., while also assigning context to objects.

At the simplest level, neurons in the human brain look at various inputs that are received, importance levels are assigned to each of these inputs, and output is passed on to other neurons to act upon. An artificial neuron or perceptron is the most basic model of a neural network. In one example, a perceptron may receive one or more inputs that represent various features of an object that the perceptron is being trained to recognize and classify, and each of these features is assigned a certain weight based on the importance of that feature in defining the shape of an object.

A deep neural network (DNN) model includes multiple layers of many connected nodes (e.g., perceptrons, Boltzmann machines, radial basis functions, convolutional layers, etc.) that can be trained with enormous amounts of input data to quickly solve complex problems with high accuracy. In one example, a first layer of the DNN model breaks down an input image of an automobile into various sections and looks for basic patterns such as lines and angles. The second layer assembles the lines to look for higher level patterns such as wheels, windshields, and mirrors. The next layer identifies the type of vehicle, and the final few layers generate a label for the input image, identifying the model of a specific automobile brand.

Once the DNN is trained, the DNN can be deployed and used to identify and classify objects or patterns in a process known as inference. Examples of inference (the process through which a DNN extracts useful information from a given input) include identifying handwritten numbers on checks deposited into ATM machines, identifying images of friends in photos, delivering movie recommendations to over fifty million users, identifying and classifying different types of automobiles, pedestrians, and road hazards in driverless cars, or translating human speech in real-time.

During training, data flows through the DNN in a forward propagation phase until a prediction is produced that indicates a label corresponding to the input. If the neural network does not correctly label the input, then errors between the correct label and the predicted label are analyzed, and the weights are adjusted for each feature during a backward propagation phase until the DNN correctly labels the input and other inputs in a training dataset. Training complex neural networks requires massive amounts of parallel computing performance, including floating-point multiplications and additions. Inferencing is less compute-intensive than training, being a latency-sensitive process where a trained neural network is applied to new inputs it has not seen before to classify images, translate speech, and generally infer new information.

### Inference and Training Logic

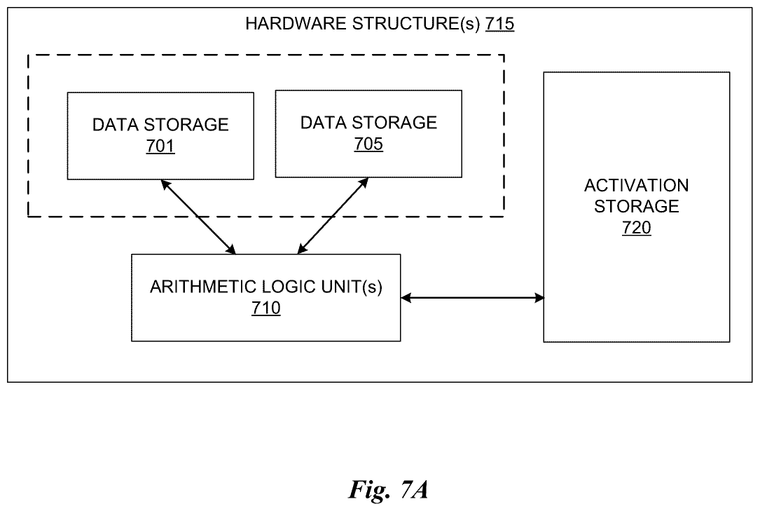

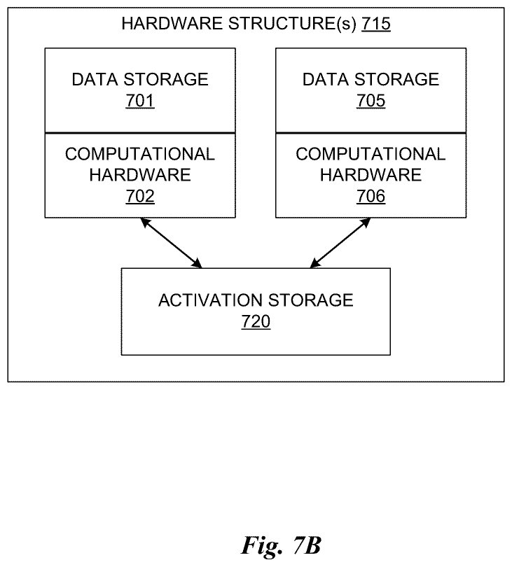

As noted above, a deep learning or neural learning system needs to be trained to generate inferences from input data. Details regarding inference and/or training logic 715 for a deep learning or neural learning system are provided below in conjunction with Figures. 7A and/or 7B.

In at least one embodiment, inference and/or training logic 715 may include, without limitation, a data storage 701 to store forward and/or output weight and/or input/output data corresponding to neurons or layers of a neural network trained and/or used for inferencing in aspects of one or more embodiments. In at least one embodiment data storage 701 stores weight parameters and/or input/output data of each layer of a neural network trained or used in conjunction with one or more embodiments during forward propagation of input/output data and/or weight parameters during training and/or inferencing using aspects of one or more embodiments. In at least one embodiment, any portion of data storage 701 may be included with other on-chip or off-chip data storage, including a processor's L1, L2, or L3 cache or system memory.

In at least one embodiment, any portion of data storage 701 may be internal or external to one or more processors or other hardware logic devices or circuits. In at least one embodiment, data storage 701 may be cache memory, dynamic randomly addressable memory (“DRAM”), static randomly addressable memory (“SRAM”), non-volatile memory (e.g., Flash memory), or other storage. In at least one embodiment, choice of whether data storage 701 is internal or external to a processor, for example, or comprised of DRAM, SRAM, Flash or some other storage type may depend on available storage on-chip versus off-chip, latency requirements of training and/or inferencing functions being performed, batch size of data used in inferencing and/or training of a neural network, or some combination of these factors.

In at least one embodiment, inference and/or training logic 715 may include, without limitation, a data storage 705 to store backward and/or output weight and/or input/output data corresponding to neurons or layers of a neural network trained and/or used for inferencing in aspects of one or more embodiments. In at least one embodiment, data storage 705 stores weight parameters and/or input/output data of each layer of a neural network trained or used in conjunction with one or more embodiments during backward propagation of input/output data and/or weight parameters during training and/or inferencing using aspects of one or more embodiments. In at least one embodiment, any portion of data storage 705 may be included with other on-chip or off-chip data storage, including a processor's L1, L2, or L3 cache or system memory. In at least one embodiment, any portion of data storage 705 may be internal or external to on one or more processors or other hardware logic devices or circuits. In at least one embodiment, data storage 705 may be cache memory, DRAM, SRAM, non-volatile memory (e.g., Flash memory), or other storage. In at least one embodiment, choice of whether data storage 705 is internal or external to a processor, for example, or comprised of DRAM, SRAM, Flash or some other storage type may depend on available storage on-chip versus off-chip, latency requirements of training and/or inferencing functions being performed, batch size of data used in inferencing and/or training of a neural network, or some combination of these factors.

In at least one embodiment, data storage 701 and data storage 705 may be separate storage structures. In at least one embodiment, data storage 701 and data storage 705 may be same storage structure. In at least one embodiment, data storage 701 and data storage 705 may be partially same storage structure and partially separate storage structures. In at least one embodiment, any portion of data storage 701 and data storage 705 may be included with other on-chip or off-chip data storage, including a processor's Ll, L2, or L3 cache or system memory.

In at least one embodiment, inference and/or training logic 715 may include, without limitation, one or more arithmetic logic unit(s) (“ALU(s)”) 710 to perform logical and/or mathematical operations based, at least in part on, or indicated by, training and/or inference code, result of which may result in activations (e.g., output values from layers or neurons within a neural network) stored in an activation storage 720 that are functions of input/output and/or weight parameter data stored in data storage 701 and/or data storage 705. In at least one embodiment, activations stored in activation storage 720 are generated according to linear algebraic and or matrix-based mathematics performed by ALU(s) 710 in response to performing instructions or other code, wherein weight values stored in data storage 705 and/or data 701 are used as operands along with other values, such as bias values, gradient information, momentum values, or other parameters or hyperparameters, any or all of which may be stored in data storage 705 or data storage 701 or another storage on or off-chip. In at least one embodiment, ALU(s) 710 are included within one or more processors or other hardware logic devices or circuits, whereas in another embodiment, ALU(s) 710 may be external to a processor or other hardware logic device or circuit that uses them (e.g., a co-processor). In at least one embodiment, ALUs 710 may be included within a processor's execution units or otherwise within a bank of ALUs accessible by a processor's execution units either within same processor or distributed between different processors of different types (e.g., central processing units, graphics processing units, fixed function units, etc.). In at least one embodiment, data storage 701, data storage 705, and activation storage 720 may be on same processor or other hardware logic device or circuit, whereas in another embodiment, they may be in different processors or other hardware logic devices or circuits, or some combination of same and different processors or other hardware logic devices or circuits. In at least one embodiment, any portion of activation storage 720 may be included with other on-chip or off-chip data storage, including a processor's Ll, L2, or L3 cache or system memory. Furthermore, inferencing and/or training code may be stored with other code accessible to a processor or other hardware logic or circuit and fetched and/or processed using a processor's fetch, decode, scheduling, execution, retirement and/or other logical circuits.

In at least one embodiment, activation storage 720 may be cache memory, DRAM, SRAM, non-volatile memory (e.g., Flash memory), or other storage. In at least one embodiment, activation storage 720 may be completely or partially within or external to one or more processors or other logical circuits. In at least one embodiment, choice of whether activation storage 720 is internal or external to a processor, for example, or comprised of DRAM, SRAM, Flash or some other storage type may depend on available storage on-chip versus off-chip, latency requirements of training and/or inferencing functions being performed, batch size of data used in inferencing and/or training of a neural network, or some combination of these factors. In at least one embodiment, inference and/or training logic 715 illustrated in FIG. 7A may be used in conjunction with an application-specific integrated circuit (“ASIC”), such as Tensorflow® Processing Unit from Google, an inference processing unit (IPU) from Graphcore™, or a Nervana® (e.g., “Lake Crest”) processor from Intel Corp. In at least one embodiment, inference and/or training logic 715 illustrated in FIG. 7A may be used in conjunction with central processing unit (“CPU”) hardware, graphics processing unit (“GPU”) hardware or other hardware, such as field programmable gate arrays (“FPGAs”).

FIG. 7B illustrates inference and/or training logic 715, according to at least one embodiment. In at least one embodiment, inference and/or training logic 715 may include, without limitation, hardware logic in which computational resources are dedicated or otherwise exclusively used in conjunction with weight values or other information corresponding to one or more layers of neurons within a neural network. In at least one embodiment, inference and/or training logic 715 illustrated in FIG. 7B may be used in conjunction with an application-specific integrated circuit (ASIC), such as Tensorflow® Processing Unit from Google, an inference processing unit (IPU) from Graphcore™, or a Nervana® (e.g., “Lake Crest”) processor from Intel Corp. In at least one embodiment, inference and/or training logic 715 illustrated in FIG. 7B may be used in conjunction with central processing unit (CPU) hardware, graphics processing unit (GPU) hardware or other hardware, such as field programmable gate arrays (FPGAs). In at least one embodiment, inference and/or training logic 715 includes, without limitation, data storage 701 and data storage 705, which may be used to store weight values and/or other information, including bias values, gradient information, momentum values, and/or other parameter or hyperparameter information. In at least one embodiment illustrated in FIG. 7B, each of data storage 701 and data storage 705 is associated with a dedicated computational resource, such as computational hardware 702 and computational hardware 706, respectively. In at least one embodiment, each of computational hardware 706 comprises one or more ALUs that perform mathematical functions, such as linear algebraic functions, only on information stored in data storage 701 and data storage 705, respectively, result of which is stored in activation storage 720.

In at least one embodiment, each of data storage 701 and 705 and corresponding computational hardware 702 and 706, respectively, correspond to different layers of a neural network, such that resulting activation from one “storage/computational pair 701/702” of data storage 701 and computational hardware 702 is provided as an input to next “storage/computational pair 705/706” of data storage 705 and computational hardware 706, in order to mirror conceptual organization of a neural network. In at least one embodiment, each of storage/computational pairs 701/702 and 705/706 may correspond to more than one neural network layer. In at least one embodiment, additional storage/computation pairs (not shown) subsequent to or in parallel with storage computation pairs 701/702 and 705/706 may be included in inference and/or training logic 715.

### Neural Network Training and Deployment

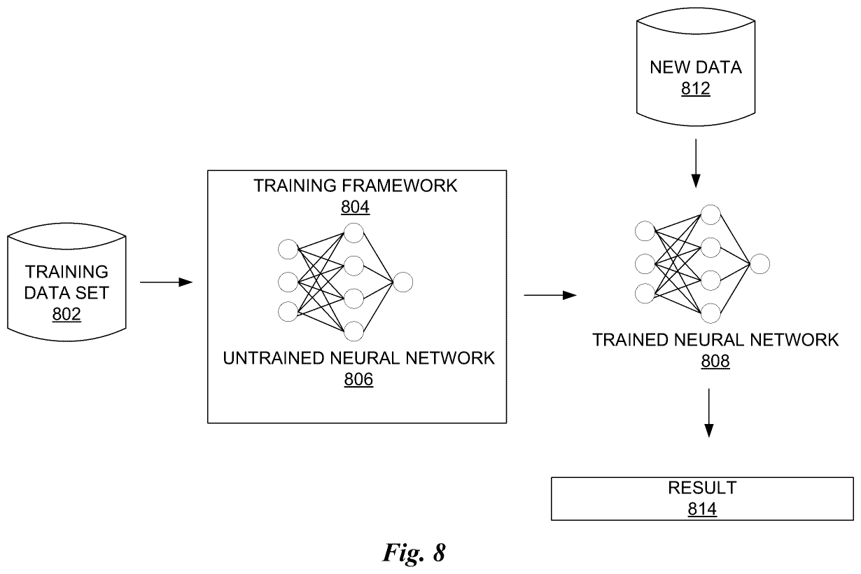

FIG. 8 illustrates another embodiment for training and deployment of a deep neural network. In at least one embodiment, untrained neural network 806 is trained using a training dataset 802. In at least one embodiment, training framework 804 is a PyTorch framework, whereas in other embodiments, training framework 804 is a Tensorflow, Boost, Caffe, Microsoft Cognitive Toolkit/CNTK, MXNet, Chainer, Keras, Deeplearning4j, or other training framework. In at least one embodiment training framework 804 trains an untrained neural network 806 and enables it to be trained using processing resources described herein to generate a trained neural network 808. In at least one embodiment, weights may be chosen randomly or by pre-training using a deep belief network. In at least one embodiment, training may be performed in either a supervised, partially supervised, or unsupervised manner.

In at least one embodiment, untrained neural network 806 is trained using supervised learning, wherein training dataset 802 includes an input paired with a desired output for an input, or where training dataset 802 includes input having known output and the output of the neural network is manually graded. In at least one embodiment, untrained neural network 806 is trained in a supervised manner processes inputs from training dataset 802 and compares resulting outputs against a set of expected or desired outputs. In at least one embodiment, errors are then propagated back through untrained neural network 806. In at least one embodiment, training framework 804 adjusts weights that control untrained neural network 806. In at least one embodiment, training framework 804 includes tools to monitor how well untrained neural network 806 is converging towards a model, such as trained neural network 808, suitable to generating correct answers, such as in result 814, based on known input data, such as new data 812. In at least one embodiment, training framework 804 trains untrained neural network 806 repeatedly while adjust weights to refine an output of untrained neural network 806 using a loss function and adjustment algorithm, such as stochastic gradient descent. In at least one embodiment, training framework 804 trains untrained neural network 806 until untrained neural network 806 achieves a desired accuracy. In at least one embodiment, trained neural network 808 can then be deployed to implement any number of machine learning operations.

In at least one embodiment, untrained neural network 806 is trained using unsupervised learning, wherein untrained neural network 806 attempts to train itself using unlabeled data. In at least one embodiment, unsupervised learning training dataset 802 will include input data without any associated output data or “ground truth” data. In at least one embodiment, untrained neural network 806 can learn groupings within training dataset 802 and can determine how individual inputs are related to untrained dataset 802. In at least one embodiment, unsupervised training can be used to generate a self-organizing map, which is a type of trained neural network 808 capable of performing operations useful in reducing dimensionality of new data 812. In at least one embodiment, unsupervised training can also be used to perform anomaly detection, which allows identification of data points in a new dataset 812 that deviate from normal patterns of new dataset 812.

In at least one embodiment, semi-supervised learning may be used, which is a technique in which in training dataset 802 includes a mix of labeled and unlabeled data. In at least one embodiment, training framework 804 may be used to perform incremental learning, such as through transferred learning techniques. In at least one embodiment, incremental learning enables trained neural network 808 to adapt to new data 812 without forgetting knowledge instilled within network during initial training.

### Data Center

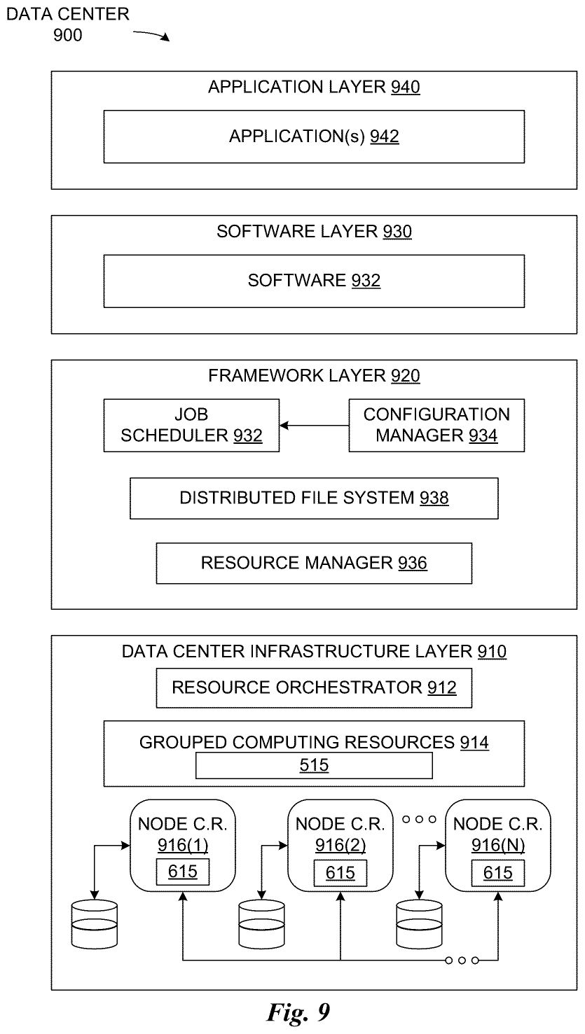

FIG. 9 illustrates an example data center 900, in which at least one embodiment may be used. In at least one embodiment, data center 900 includes a data center infrastructure layer 910, a framework layer 920, a software layer 930 and an application layer 940.

In at least one embodiment, as shown in FIG. 9, data center infrastructure layer 910 may include a resource orchestrator 912, grouped computing resources 914, and node computing resources (“node C.R.s”) 916(1)-916(N), where “N” represents any whole, positive integer. In at least one embodiment, node C.R.s 916(1)-916(N) may include, but are not limited to, any number of central processing units (“CPUs”) or other processors (including accelerators, field programmable gate arrays (FPGAs), graphics processors, etc.), memory devices (e.g., dynamic read-only memory), storage devices (e.g., solid state or disk drives), network input/output (“NW I/O”) devices, network switches, virtual machines (“VMs”), power modules, and cooling modules, etc. In at least one embodiment, one or more node C.R.s from among node C.R.s 916(1)-916(N) may be a server having one or more of above-mentioned computing resources.

In at least one embodiment, grouped computing resources 914 may include separate groupings of node C.R.s housed within one or more racks (not shown), or many racks housed in data centers at various geographical locations (also not shown). Separate groupings of node C.R.s within grouped computing resources 914 may include grouped compute, network, memory or storage resources that may be configured or allocated to support one or more workloads. In at least one embodiment, several node C.R.s including CPUs or processors may grouped within one or more racks to provide compute resources to support one or more workloads. In at least one embodiment, one or more racks may also include any number of power modules, cooling modules, and network switches, in any combination.

In at least one embodiment, resource orchestrator 922 may configure or otherwise control one or more node C.R.s 916(1)-916(N) and/or grouped computing resources 914. In at least one embodiment, resource orchestrator 922 may include a software design infrastructure (“SDI”) management entity for data center 900. In at least one embodiment, resource orchestrator may include hardware, software or some combination thereof.

In at least one embodiment, as shown in FIG. 9, framework layer 920 includes a job scheduler 932, a configuration manager 934, a resource manager 936 and a distributed file system 938. In at least one embodiment, framework layer 920 may include a framework to support software 932 of software layer 930 and/or one or more application(s) 942 of application layer 940. In at least one embodiment, software 932 or application(s) 942 may respectively include web-based service software or applications, such as those provided by Amazon Web Services, Google Cloud and Microsoft Azure. In at least one embodiment, framework layer 920 may be, but is not limited to, a type of free and open-source software web application framework such as Apache Spark™ (hereinafter “Spark”) that may utilize distributed file system 938 for large-scale data processing (e.g., “big data”). In at least one embodiment, job scheduler 932 may include a Spark driver to facilitate scheduling of workloads supported by various layers of data center 900. In at least one embodiment, configuration manager 934 may be capable of configuring different layers such as software layer 930 and framework layer 920 including Spark and distributed file system 938 for supporting large-scale data processing. In at least one embodiment, resource manager 936 may be capable of managing clustered or grouped computing resources mapped to or allocated for support of distributed file system 938 and job scheduler 932. In at least one embodiment, clustered or grouped computing resources may include grouped computing resource 914 at data center infrastructure layer 910. In at least one embodiment, resource manager 936 may coordinate with resource orchestrator 912 to manage these mapped or allocated computing resources.

In at least one embodiment, software 932 included in software layer 930 may include software used by at least portions of node C.R.s 916(1)-916(N), grouped computing resources 914, and/or distributed file system 938 of framework layer 920. one or more types of software may include, but are not limited to, Internet web page search software, e-mail virus scan software, database software, and streaming video content software.

In at least one embodiment, application(s) 942 included in application layer 940 may include one or more types of applications used by at least portions of node C.R.s 916(1)-916(N), grouped computing resources 914, and/or distributed file system 938 of framework layer 920. one or more types of applications may include, but are not limited to, any number of a genomics application, a cognitive compute, and a machine learning application, including training or inferencing software, machine learning framework software (e.g., PyTorch, TensorFlow, Caffe, etc.) or other machine learning applications used in conjunction with one or more embodiments.

In at least one embodiment, any of configuration manager 934, resource manager 936, and resource orchestrator 912 may implement any number and type of self-modifying actions based on any amount and type of data acquired in any technically feasible fashion. In at least one embodiment, self-modifying actions may relieve a data center operator of data center 900 from making possibly bad configuration decisions and possibly avoiding underutilized and/or poor performing portions of a data center.

In at least one embodiment, data center 900 may include tools, services, software or other resources to train one or more machine learning models or predict or infer information using one or more machine learning models according to one or more embodiments described herein. For example, in at least one embodiment, a machine learning model may be trained by calculating weight parameters according to a neural network architecture using software and computing resources described above with respect to data center 900. In at least one embodiment, trained machine learning models corresponding to one or more neural networks may be used to infer or predict information using resources described above with respect to data center 900 by using weight parameters calculated through one or more training techniques described herein.

In at least one embodiment, data center may use CPUs, application-specific integrated circuits (ASICs), GPUs, FPGAs, or other hardware to perform training and/or inferencing using above-described resources. Moreover, one or more software and/or hardware resources described above may be configured as a service to allow users to train or performing inferencing of information, such as image recognition, speech recognition, or other artificial intelligence services.

Inference and/or training logic 615 are used to perform inferencing and/or training operations associated with one or more embodiments. In at least one embodiment, inference and/or training logic 615 may be used in system FIG. 9 for inferencing or predicting operations based, at least in part, on weight parameters calculated using neural network training operations, neural network functions and/or architectures, or neural network use cases described herein.

As described herein, a method, computer readable medium, and system are disclosed for learning a shape code for a three-dimensional character, which may be used for a pose transfer to the three-dimensional character. In accordance with FIGS. 1-6, embodiments may provide machine learning models usable for performing inferencing operations and for providing inferenced data. The machine learning models may be is stored (partially or wholly) in one or both of data storage 601 and 605 in inference and/or training logic 615 as depicted in FIGS. 7A and 7B. Training and deployment of the machine learning models may be performed as depicted in FIG. 8 and described herein. Distribution of the machine learning models may be performed using one or more servers in a data center 900 as depicted in FIG. 9 and described herein.

What is claimed is:

1. A method comprising:
at a device:
processing a three-dimensional character in a source pose, using a machine learning model, to learn a latent shape code for the three-dimensional character that includes:
shape information for the three-dimensional character, and
a plurality of body part segmentation labels for the three-dimensional character, each body part segmentation label of the plurality of body part segmentation labels being for a corresponding surface point in a set of surface points on the three-dimensional character; and
outputting the latent shape code.

2. The method of claim 1, wherein the three-dimensional character is a stylized quadruped.

3. The method of claim 1, wherein the three-dimensional character is a stylized biped.

4. The method of claim 1, wherein the source pose is a rest pose.

5. The method of claim 1, wherein the three-dimensional character is unseen during training of the machine learning model.

6. The method of claim 5, wherein the machine learning model is trained using supervised learning on a training data set that includes:
naked human meshes having occupancy labels and part segmentation labels, and
a plurality of other three-dimensional character rest pose meshes having occupancy labels,
wherein an occupancy label indicates whether a corresponding query point is inside or outside a body surface.

7. The method of claim 1, wherein the shape information includes a shape of each body part.

8. The method of claim 7, wherein the shape information further includes at least one of:
a physical height of the three-dimensional character, or
a physical weight of the three-dimensional character.

9. The method of claim 1, wherein the latent shape code is learned using an implicit auto-decoder that takes a learnable shape code as input and that reconstructs the three-dimensional character.

10. The method of claim 1, wherein the machine learning model includes:
a first multilayer perceptron (MLP) that, given a query point on the three-dimensional character and a learnable shape code, obtains an embedding,
a second MLP that, given the embedding, predicts an occupancy that indicates whether the query point is inside or outside a body surface of the three-dimensional character,
a third MLP that, given the embedding, predicts the part segmentation label for the query point.

11. The method of claim 10, wherein the machine learning model further includes an inverse MLP that, given the learnable shape code and the embedding, reconstructs coordinates of the query point.

12. The method of claim 1, wherein the latent shape code is output to a second machine learning model configured to deform the three-dimensional character into a target pose.

13. The method of claim 12, wherein the second machine learning model is trained using supervised learning on a training data set that includes:
human meshes in rest pose, and
deformations of the human meshes into a plurality of predefined target poses.

14. The method of claim 12, further comprising:
processing the latent shape code and a target pose code corresponding to the target pose, using the second machine learning model, to deform the three-dimensional character into the target pose; and
outputting the deformed three-dimensional character.

15. The method of claim 14, wherein deforming the three-dimensional character into the target pose includes deforming each surface point in the set of surface points on the three-dimensional character to match the target pose.

16. The method of claim 14, wherein the target pose is indicated by a non-stylized avatar.

17. The method of claim 14, wherein the target pose code is captured from a video.

18. The method of claim 14, wherein the second machine learning model includes a MLP that, given the latent shape code, the target pose code, and a query point, predicts an offset of the query point in three-dimensional space.

19. The method of claim 14, wherein the three-dimensional character in the target pose is output for applying a volume-preserving constraint to the deformed three-dimensional character.

20. The method of claim 19, wherein the volume-preserving constraint preserves, in the three-dimensional character in the target pose, a volume of each body part of the three-dimensional character in the source pose.

21. The method of claim 20, wherein the volume of each body part of the three-dimensional character in the source pose is represented by a Euclidean distance between a plurality of pairs of surface points.

22. The method of claim 21, wherein the volume of each body part of the three-dimensional character in the source pose is preserved by minimizing, for each pair of surface points, a change in a distance of the two surface points in the pair on the three-dimensional character in the target pose, wherein the change is minimized according to a predefined function.

23. The method of claim 19, further comprising:
performing test-time training of the second machine learning model to optimize weights of the second machine learning model by fine-tuning on the given pose and the three-dimensional character with a volume-preserving objective, such that it can deform the three-dimensional character to the target pose more naturally and smoothly.

24. A system, comprising:
a non-transitory memory storage comprising instructions; and
one or more processors in communication with the memory, wherein the one or more processors execute the instructions to:
process a three-dimensional character in a source pose, using a machine learning model, to learn a latent shape code for the three-dimensional character that includes:
shape information for the three-dimensional character, and
a plurality of body part segmentation labels for the three-dimensional character, each body part segmentation label of the plurality of body part segmentation labels being for a corresponding surface point in a set of surface points on the three-dimensional character; and
output the latent shape code.

25. A non-transitory computer-readable media storing computer instructions which when executed by one or more processors of a device cause the device to:
process a three-dimensional character in a source pose, using a machine learning model, to learn a latent shape code for the three-dimensional character that includes:
shape information for the three-dimensional character, and
a plurality of body part segmentation labels for the three-dimensional character, each body part segmentation label of the plurality of body part segmentation labels being for a corresponding surface point in a set of surface points on the three-dimensional character; and
output the latent shape code.
